(19) United States
(12) Patent Application Publication
(10) Pub. No.: US 2025/0224146 A1
(43) Pub. Date: Jul. 10, 2025

(54) SYSTEMS AND METHODS FOR INCREASING ENERGY HARVESTING OF SOLAR HYDRONIC WATER HEATING SYSTEMS FOR SWIMMING POOLS

(71) Applicant: FLUIDRA GROUP AUSTRALIA PTY LTD., Smithfield NSW (AU)

(72) Inventors: Steve Fallon, Smithfield NSW (AU); Anthony Lestani, Smithfield NSW (AU); Dime Risteski, Smithfield NSW (AU)

(73) Assignee: FLUIDRA GROUP AUSTRALIA PTY LTD., Smithfield NSW (AU)

(21) Appl. No.: 19/007,747

(22) Filed: Jan. 2, 2025

Related U.S. Application Data
(60) Provisional application No. 63/617,882, filed on Jan. 5, 2024.

(51) Int. Cl. F24S 10/10

(52) U.S. Cl. CPC F24S 10/10

(57) ABSTRACT

A pool system may include a solar heating system for heating water of a swimming pool or spa comprising. The solar heating system includes a collector which may receive water from the swimming pool or spa and heat a flow of water from the swimming pool or spa using solar radiation. The solar heating system includes one or more control devices, which may control a flow rate of water through the solar heating system and/or a pressure of water through the solar heating system.

### REFERENCE TO RELATED APPLICATION

This application claims the benefit of and priority to U.S. Provisional Patent Application No. 63/617,882, filed on Jan. 5, 2024, and entitled SYSTEMS AND METHODS FOR INCREASING ENERGY HARVESTING OF SOLAR HYDRONIC WATER HEATING SYSTEMS FOR SWIMMING POOLS, the content of which is hereby incorporated by reference in its entirety.

### FIELD OF THE INVENTION

The invention relates to heating systems for swimming pools and spas, and, more particularly, to swimming pool heating systems employing solar radiation as a primary heat source.

### BACKGROUND OF THE INVENTION

Swimming pools and spas may include one or more heating systems for heating water of the swimming pool or spa. The heating systems may utilize various heating methods, and an environmentally-sustainable means of heating water of the swimming pool or spa is to use solar radiation to directly heat pipes or conduit circulating the water of the swimming pool or spa. Such solar heating systems, also known as solar hydronic heating systems, typically install a heat absorbent surface (also referred to herein as a “collector”), often formed of flexible or rigid pipework, across a roof of a building. Traditionally, the water of the swimming pool or spa is pumped through the pipework and the collector on the roof using a pump having a speed which is fixed by design (e.g., a single speed pump) or fixed for the benefit of other pool processes (e.g., chlorination, filtering, etc.). The fixed speed pumps of such traditional solar heating systems prevent suction created by gravity on the water returning to the swimming pool from emptying the collector but may be relatively inefficient at heating the water.

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a solar heating system for a swimming pool or spa includes a collector for receiving and heating a flow of water from the swimming pool or spa using solar radiation and one or more control devices controlling a flow rate and/or pressure of the water through the solar heating system.

According to various embodiments, a solar heating system for a swimming pool or spa includes a collector for receiving and heating a flow of water from the swimming pool or spa using solar radiation and at least one of a variable speed pump or a valve for controlling a flow rate and/or pressure of water from the swimming pool or spa traversing the solar heating system.

According to some embodiments, a solar heating system for a swimming pool or spa includes one or more control devices controlling a flow rate and/or pressure of water traversing a collector of the solar heating system that heats the water using solar radiation. The solar heating system additionally includes one or more temperature sensors and a control system for controlling the one or more control devices based on sensor data from the one or more temperature sensors.

According to certain embodiments, a method of heating water of a swimming pool or spa includes controlling a flow rate and/or pressure of water through a collector of a solar heating system.

According to various embodiments, a method of heating water of a swimming pool or spa includes controlling a flow rate and/or pressure of water through a collector of a solar heating system based on temperature data from one or more temperature sensors.

According to some embodiments, a method of heating water of a swimming pool or spa includes controlling a variable speed pump and/or a valve of a solar heating system to control a flow rate and/or pressure of water traversing the solar heating system.

Various implementations described herein can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different figures is intended to illustrate like or analogous components.

FIG. 1 illustrates a pool system with a solar hydronic heating system according to embodiments.

### DETAILED DESCRIPTION

Described herein are systems and methods for improving energy absorption of solar hydronic heating systems for swimming pools and spas by controlling water flow and/or pressure control. In some embodiments, the systems and methods described herein may control the flow rate and/or pressure of the water passing through the collector of the solar heating system. Controlling the flow rate and/or pressure of the water passing through the collector may allow for an increased amount of solar radiation to be captured and absorbed compared to existing systems with fixed speed pumps, thereby improving heating performance of the solar heating system. In some embodiments, the systems and methods described herein may control the flow rate and/or pressure of water by utilizing one or more physical devices to optimize the flow and/or pressure within the system. As non-limiting examples, the systems and methods described herein may utilize variable speed water pumps, flow restricting valves, combinations thereof, and/or other flow control devices as desired. In some embodiments, the systems and methods described herein may include a closed loop control system with feedback from one or more sensors used to control the flow rate and/or pressure. As non-limiting examples, the flow rate and/or pressure may be controlled based on a temperature of water at an outlet of the collector, a roof temperature (e.g., available solar radiation), a temperature of the swimming pool (e.g., measured at an inlet to the heating system), combinations thereof, and/or other sensed information as desired.

Flow and/or pressure control of the water traversing the heating system using the systems and methods described herein results in an increase in heat transfer from the solar radiation to the swimming pool water. As examples, the flow and/or pressure may be controlled to maximize energy absorption (and/or provide desired levels of energy absorption) as the water traverses the heating system. Modulation and moderation of these flows and/or pressures may be conducted in real-time and/or automatically (e.g., by a control system), optionally based on sensor data such as but not limited to temperature sensor data. Various other benefits and advantages may be realized with the systems and methods provided herein, and the aforementioned advantages should not be considered limiting.

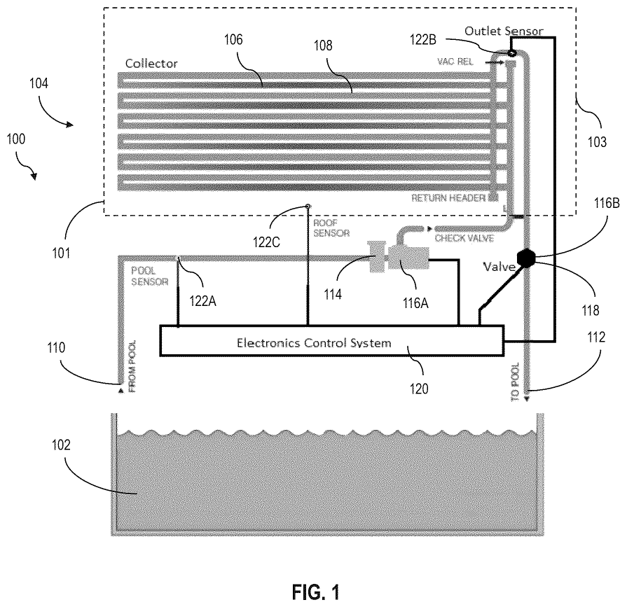

FIG. 1 illustrates an example of a pool system 100 according to embodiments. The pool system 100 generally includes a swimming pool or spa 102 (hereinafter “pool 102”) and a solar heating system 104. The solar heating system 104 generally includes a collector 106 formed of conduit 108, one or more inlets 110 for receiving water from the pool 102, and one or more outlets 112 for returning water to the pool 102 after passing through the collector 106. The collector 106 may be provided at various locations 101 as desired such as on a roof 103 of a building or structure, a location proximate to the pool 102, and/or as otherwise desired and suitable for receiving solar radiation.

In addition to the collector 106, the solar heating system 104 includes a pump 114 for pumping water from the pool 102 through the collector 106.

In various embodiments, and as illustrated in FIG. 1, the solar heating system 104 includes one or more control devices 116 for controlling a flow rate and/or pressure of water flowing through the solar heating system 104. The control devices 116 may be various devices suitable for controlling the flow rate and/or pressure of water, such as but not limited to variable speed water pumps, flow restricting valves, combinations thereof, and/or other flow control devices 116 as desired. In the embodiment of FIG. 1, the control device 116A is a variable speed pump 114, and the control device 116B is a valve 118. While two control devices 116A-B are illustrated in FIG. 1, in other embodiments, any number of control devices 116 may be utilized, including a single control device 116 and/or more than two control devices 116. In embodiments with more than one control devices 116, the control devices 116 need not be a same type of control device. As a non-limiting example, in FIG. 1, the control device 116A is the variable speed pump 114 and the control device 116B is the valve 118. As a further non-limiting example, a pool system may include only one or more valves 118 as control devices 116, only the variable speed pump 114 as the control device 116, and/or other control devices 116 or combinations thereof as desired.

In some embodiments, the control devices 116 may be manually controlled, although in other embodiments and as discussed in detail below, the control devices 116 may be automatically controlled by a control system 120. In embodiments with a plurality of control devices 116, the control devices 116 may be independently controlled or jointly controlled as desired to control the flow rate and/or pressure of water flowing through the solar heating system 104. As non-limiting examples, in FIG. 1, the flow rate and/or pressure of water may be controlled by controlling the variable speed pump 114, the valve 118, and/or both the variable speed pump 114 and the valve 118. In some embodiments, the solar heating system 104 may be controlled in various modes in which various control devices 116 or combinations of control devices 116 are controlled to provide a desired flow rate and/or pressure.

As illustrated in FIG. 1, in certain embodiments, the solar heating system 104 optionally includes the control system 120. The control system 120 (one or more processing units and/or memory devices) may be communicatively coupled to the control devices 116 using various communication techniques as desired.

The one or more processing units of the control system 120 may be any suitable processing device or combinations of devices including but not limited to one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units, and/or a combination thereof. The one or more memory devices of the control system 120 may be any machine-readable medium that can be accessed by the processor, including but not limited to any type of long term, short term, volatile, nonvolatile, or other storage medium, and is not to be limited to any particular type of memory or number of memories, or type of media upon which memory is stored. Moreover, as disclosed herein, the term “storage medium,” “storage” or “memory” can represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to, portable or fixed storage devices, optical storage devices, wireless channels, and/or various other storage mediums capable of storing that contain or carry instruction(s) and/or data.

In certain embodiments, the control system 120 optionally includes an associated user interface, including but not limited to a human machine user interface, such that the control system 120 may obtain information from a user and/or provide information to the user via the user interface. When included, the user interface may be on the control system 120 itself or may be at a location remote from the control system 120 such as, but not limited to, another location within the pool system 100. Additionally, or alternatively, the control system 120 optionally may include one or more communication modules such that the control system 120 may receive and/or send information to a user device and/or other location. Non-limiting examples of communication modules may include systems and mechanisms enabling wired communication and/or wireless communication (e.g., near field, cellular, Wi-Fi, Bluetooth®, Bluetooth Low Energy (BLE), low-power wide area network, cloud-based communication etc.). In one non-limiting example, the control system 120 may receive and/or send information to a user device via an application running on the user device.

In various embodiments, the control system 120 may automatically control the control devices 116 to control the flow rate and/or the pressure of water. As non-limiting examples, the control system 120 may control the variable speed pump 114 to operate at a desired speed, and/or may control a position of the valve 118 (e.g., fully open, fully closed, partially open, etc.).

In some embodiments, the control system 120 may control the control devices 116 based on information received from a user (e.g., via a user device, user interface, etc.). Additionally, or alternatively, the control system 120 may control the control devices 116 based on sensor data from one or more sensors 122 of the pool system 100. In such embodiments, the control system 120 may be communicatively coupled to the one or more sensors 122 using various communication techniques as desired and such that the sensor data from the one or more sensors 122 may be provided to the control system 120.

In embodiments with the one or more sensors 122, any number of sensors 122 may be utilized, and the sensors 122 may be various types of sensors as desired detecting one or more characteristics of the pool system 100. As non-limiting examples, the sensors 122 may be temperature sensors, flow sensors, pressure sensors, combinations thereof, and/or other sensors as desired. In the embodiment of FIG. 1, the pool system 100 includes three temperature sensors 122A-C of which temperature sensor 122A measures a temperature of water from the swimming pool 102 (e.g., entering the solar heating system 104), temperature sensor 122B measures a temperature of water exiting the collector 106 (e.g., returning to the pool 102), and temperature sensor 122C measures a temperature of the location (e.g., roof) of the collector 106 (thereby measuring available solar radiation). In other embodiments, additional or fewer temperature sensors may be utilized and/or other types of sensors may be utilized.

Various controls of the control devices 116 may be implemented based on the sensor data and/or to control the flow rate and/or pressure of water flowing through the solar heating system 104 as desired.

As a non-limiting example, the control system 120 may predict and/or estimate heating of water flowing through the solar heating system 104 at various flow rates and/or pressures based on the sensor data from the temperature sensor 122C. In this example, the control system 120 may further control one or more of the control devices 116 to be at a desired flow rate and/or pressure (thus providing an estimated amount of heating) based on a difference between sensor data from the temperature sensor 122B and the temperature sensor 122A.

As a further non-limiting example, the control system 120 may estimate or predict an outlet temperature of water based on available solar radiation from temperature sensors 122C and may further control one or more of the control devices 116 based on a difference between the predicted temperature and an actual temperature as measured by temperature sensor 122B.

Various other controls may be utilized as desired, and the aforementioned examples of control should not be considered limiting.

Exemplary concepts or combinations of features of the invention may include:
A. A pool system comprising a solar heating system for a swimming pool or spa, the solar heating system comprising:
   i. a collector configured to receive and heat a flow of water from the swimming pool or spa using solar radiation; and
   ii. one or more control devices controlling a flow rate and/or pressure of the water through the solar heating system.
B. A pool system comprising a solar heating system for a swimming pool or spa, the solar heating system comprising:
   i. a collector configured to receive and heat a flow of water from the swimming pool or spa using solar radiation; and
   ii. at least one of a variable speed pump or a valve for controlling a flow rate and/or pressure of water from the swimming pool or spa traversing the solar heating system.
C. A pool system comprising a solar heating system for a swimming pool or spa, the solar heating system comprising:
   i. one or more control devices controlling a flow rate and/or pressure of water traversing a collector of the solar heating system that heats the water using solar radiation;
   ii. one or more temperature sensors; and
   iii. a control system configured to control the one or more control devices based on sensor data from the one or more temperature sensors.
D. A pool system comprising a solar heating system for a swimming pool or spa, the solar heating system comprising:
   i. one or more control devices controlling a flow rate and/or pressure of water traversing a collector of the solar heating system that heats the water using solar radiation;
   ii. one or more sensors for detecting a characteristic of the pool system; and
   iii. a control system configured to control the one or more control devices based on sensor data from the one or more sensors.
E. The pool system of any preceding or subsequent statement or combination of statements, further comprising one or more sensors for detecting a characteristic of the pool system and a control system configured to control the one or more control devices based on sensor data from the one or more sensors.
F. The pool system of any preceding or subsequent statement or combination of statements, wherein the one or more sensors are one or more temperature sensors configured to detect a temperature of the water at an outlet of the collector.
G. The pool system of any preceding or subsequent statement or combination of statements, wherein the one or more sensors are one or more temperature sensors configured to detect an air temperature of a location at which the collector is installed.
H. The pool system of any preceding or subsequent statement or combination of statements, wherein the one or more sensors are one or more temperature sensors configured to detect a temperature of the water at an inlet to the solar heating system
I. The pool system of any preceding or subsequent statement or combination of statements, wherein the one or more control devices comprises at least two control devices, and wherein the at least two control devices are different types of flow control devices.
J. The pool system of any preceding or subsequent statement or combination of statements, wherein the one or more control devices comprises at least one of a variable speed pump or a valve.
K. The pool system of any preceding or subsequent statement or combination of statements, wherein the solar heating system comprises both the variable speed pump and the valve.
L. The pool system of any preceding or subsequent statement or combination of statements, wherein the one or more control devices comprises a pump, and wherein the control system is configured to control a speed or operational status of the pump based on the sensor data from the one or more sensors.
M. The pool system of any preceding or subsequent statement or combination of statements, wherein the one or more control devices comprises a valve controlling the flow of water to or from the collector, and wherein the control system is configured to control a position of the valve based on the sensor data from the one or more sensors.
N. The pool system of any preceding or subsequent statement or combination of statements, wherein the one or more sensors comprise one or more pressure sensors configured to detect a pressure within the solar heating system.
O. The pool system of any preceding or subsequent statement or combination of statements, wherein the one or more sensors comprise one or more flow sensors configured to detect a flow of water through the solar heating system.
P. A solar heating system for a swimming pool or spa comprising a collector and at least one control device for controlling a flow rate and/or pressure of water through the collector.
Q. A solar heating system for a swimming pool or spa comprising at least one control device for controlling a flow rate and/or pressure of water through the collector and at least one sensor.
R. A method of heating water of a swimming pool or spa, the method comprising controlling a flow rate and/or pressure of water through a collector of a solar heating system.
S. A method of heating water of a swimming pool or spa, the method comprising controlling a flow rate and/or pressure of water through a collector of a solar heating system based on temperature data from one or more temperature sensors.
T. A method of heating water of a swimming pool or spa, the method comprising controlling a variable speed pump and/or a valve of a solar heating system to control a flow rate and/or pressure of water traversing the solar heating system.
U. A non-transitory computer readable storage medium comprising a plurality of instructions executable by one or more processors, which, when executed on the one or more processors, cause the one or more processors to perform actions including any preceding or subsequent statement or combination of statements.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Further, although applicant has described devices and techniques for use principally with swimming pools and spas, persons skilled in the relevant field will recognize that the present invention conceivably could be employed in connection with other objects and in other manners. Finally, references to “pools” and “swimming pools” herein may also refer to spas or other water containing vessels used for recreation, training, or therapy.

The subject matter of embodiments is described herein with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. Directional references such as “up,” “down,” “top,” “bottom,” “left,” “right,” “front,” and “back,” among others, are intended to refer to the orientation as illustrated and described in the FIGURE (or figures) to which the components and directions are referencing. In the figures and the description, like numerals are intended to represent like elements. Throughout this disclosure, a reference numeral with a letter refers to a specific instance of an element and the reference numeral without an accompanying letter refers to the element generically or collectively. Thus, as an example (not shown in the drawings), device “12A” refers to an instance of a device class, which may be referred to collectively as devices “12” and any one of which may be referred to generically as a device “12”. As used herein, the meaning of “a,” “an,” and “the” includes singular and plural references unless the context clearly dictates otherwise.

The above-described aspects are merely possible examples of implementations, merely set forth for a clear understanding of the principles of the present disclosure. Many variations and modifications may be made to the above-described embodiment(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described embodiments, nor the claims that follow.

That which is claimed:

1. A pool system comprising a solar heating system for a swimming pool or spa comprising, the solar heating system comprising:
a collector configured to receive and heat a flow of water from the swimming pool or spa using solar radiation; and
one or more control devices controlling a flow rate and/or pressure of the water through the solar heating system.

2. The pool system of claim 1, further comprising:
one or more sensors for detecting a characteristic of the pool system; and
a control system configured to control the one or more control devices based on sensor data from the one or more sensors.

3. The pool system of claim 2, wherein the one or more sensors are one or more temperature sensors configured to detect a temperature of the water at an outlet of the collector.

4. The pool system of claim 2, wherein the one or more sensors are one or more temperature sensors configured to detect an air temperature of a location at which the collector is installed.

5. The pool system of claim 2, wherein the one or more sensors are one or more temperature sensors configured to detect a temperature of the water at an inlet to the solar heating system.

6. The pool system of claim 1, wherein the one or more control devices comprises at least two control devices, and wherein the at least two control devices are different types of flow control devices.

7. The pool system of claim 1, wherein the one or more control devices comprises at least one of a variable speed pump or a valve.

8. A pool system comprising a solar heating system for a swimming pool or spa, the solar heating system comprising:
a collector configured to receive and heat a flow of water from the swimming pool or spa using solar radiation; and
at least one of a variable speed pump or a valve for controlling a flow rate and/or pressure of water from the swimming pool or spa traversing the solar heating system.

9. The pool system of claim 8, wherein the solar heating system comprises both the variable speed pump and the valve.

10. The pool system of claim 8, further comprising a control system configured to automatically control the variable speed pump or the valve.

11. The pool system of claim 10, further comprising one or more sensors for detecting a characteristic of the pool system, wherein the control system is configured to automatically control the variable speed pump or the valve based on data from the one or more sensors.

12. The pool system of claim 11, wherein the characteristic of the pool system comprises at least one of an air temperature, a water temperature at an inlet of the solar heating system, a water temperature at an outlet of the solar heating system, or a pressure within the solar heating system.

13. A pool system comprising a solar heating system for a swimming pool or spa, the solar heating system comprising:
one or more control devices controlling a flow rate and/or pressure of water traversing a collector of the solar heating system that heats the water using solar radiation;
one or more sensors for detecting a characteristic of the pool system; and
a control system configured to control the one or more control devices based on sensor data from the one or more sensors.

14. The pool system of claim 13, wherein the one or more control devices comprises a pump, and wherein the control system is configured to control a speed or operational status of the pump based on the sensor data from the one or more sensors.

15. The pool system of claim 13, wherein the one or more control devices comprises a valve controlling the flow of water to or from the collector, and wherein the control system is configured to control a position of the valve based on the sensor data from the one or more sensors.

16. The pool system of claim 13, wherein the one or more control devices comprises at least two control devices, and wherein the at least two control devices are different types of flow control devices.

17. The pool system of claim 13, wherein the one or more sensors comprise one or more temperature sensors configured to detect a water temperature at an inlet of the solar heating system or a water temperature at an outlet of the solar heating system.

18. The pool system of claim 13, wherein the one or more sensors comprise one or more temperature sensors configured to detect an air temperature at a location of the collector.

19. The pool system of claim 13, wherein the one or more sensors comprise one or more pressure sensors configured to detect a pressure within the solar heating system.

20. The pool system of claim 13, wherein the one or more sensors comprise one or more flow sensors configured to detect a flow of water through the solar heating system.
